(19) United States
(12) Patent Application Publication
(10) Pub. No.: US 2011/0267204 A1
(43) Pub. Date: Nov. 3, 2011

(54) Vehicle auto-detection system

(75) Inventors: Kai-Cheng Chuang, Tainan City (TW); Tzu-Ming Wang, Fengshan City (TW); Po-Wen Hsiao, Hsinchu City (TW); Gwo-Feng Hwang, Jhudong Township (TW)

(73) Assignee: PRIME VIEW INTERNATIONAL CO., LTD., Hsinchu City (TW)

(21) Appl. No.: 12/801,554

(22) Filed: Jun. 15, 2010

(30) Foreign Application Priority Data
Apr. 28, 2010 (TW) TW099113577

(51) Int. Cl. G08G 1/01; G06T 1/00; G09G 3/34

(52) U.S. Cl. 340/933; 345/107; 345/501

(57) ABSTRACT

Disclosed is a vehicle detection system including the processing device, the bi-stable display connected to the processing device and the detector connected to the processing device. The detector detects the status information of the vehicle to be processed by the processing device, and then the processed status information is displayed on the bi-stable display. The processed status information can be displayed for a long time without power consumption. In addition, the upkeep/repair records and the status information further can be stored in the memory device, and the user is reminded to proceed the upkeep/repair and the to replace the vehicle's components.

### FIELD OF THE INVENTION

The present invention relates to a detection system. In particular, the present invention relates to a vehicle auto-detection system to display the status information of the vehicle (e.g. car) on the bi-stable display.

### BACKGROUND OF THE INVENTION

As the electronic industries rapidly develop, a plenty of electronic systems are integrated into the vehicles (e.g. cars, etc.), and vehicle's power system, safety system, vehicle control system, driving assistance system, entertainment system and wireless network system, etc. are detected through a plenty of chip modules and detectors. These information mostly are collected on the combination meter and the instruments around the driver's seat, and are transmitted and shown as sound or image. For instance, the circumstance around the car end which is detected/shot by the car reverse sensor or camera are transmitted to and shown on the screen for assisting the driver to reverse car. However, these information only can be provided to the driver upon starting or moving, while these information cannot be provided and stored when the car is not powered on or loses power.

In addition, when vehicles' components are replaced or the vehicle is kept up, the upkeep information are preserved as paper copy or electronic files in the maintenance and repair factory, the vehicle owner cannot immediately acquire the vehicle's upkeep information at the vehicle or is notified when maintenance and repair should be down. Since it is unnecessary to proceed the overhaul at any time and it only needs to overhaul within the prescribed time period, it is an important issue to develop the device or system displaying the upkeep/repair records so that the vehicle's status information and upkeep/repair information are improved.

It is therefore attempted by the applicant to deal with the above situation encountered in the prior art.

### SUMMARY OF THE INVENTION

The first aspect of the present invention provides a vehicle detection system, which includes: a processing device; a detector connected to the processing device and detecting an information of a vehicle; and a bi-stable display connected to the processing device and displaying the information processed by the processing device.

Preferably, the vehicle detection system further includes a memory device connected to the processing device and storing the processed information. The processing device is wirelessly or electrically connected to the bi-stable display, the memory device and the detector. The bi-stable display includes but not limit in micro-electro-mechanical system (MEMS) display, electrophoretic display, cholesteric liquid crystal display and electrowetting display. The information includes but not limit in power system information, safety system information, vehicle control information, driving assistance system information, entertainment system information and wireless network information. In addition, the information is status information.

The second aspect of the present invention provides a vehicle detection system, which includes: a bi-stable display; and a detector detecting an information of a vehicle to be displayed on the bi-stable display.

Preferably, the detector further includes a processing unit to process the information. The system further includes a memory device connected to the processing unit.

The third aspect of the present invention provides a display system, which includes: a bi-stable display; and a control unit controlling an information to be displayed on the bi-stable display. The information is continuously displayed thereon before updated.

Preferably, the bi-stable display further includes a processing device and a memory device, and the processing device processes the information and stores the processed information in the memory device. Furthermore, the system further includes a detector detecting the information and incorporating therein the control unit.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 depicts a diagram showing a vehicle detection system according to a first preferred embodiment of the present invention;

FIG. 2 depicts a diagram showing a vehicle detection system according to a second preferred embodiment of the present invention; and

FIG. 3 depicts a diagram showing a vehicle detection system according to a third preferred embodiment of the present invention.

### DETAILED DESCRIPTION OF THE PREFERRED EMBODIMENT

The present invention will now be described more specifically with reference to the following Embodiments. It is to be noted that the following descriptions of preferred Embodiments of this invention are presented herein for purpose of illustration and description only; it is not intended to be exhaustive or to be limited to the precise form disclosed.

Please refer to FIG. 1, detectors 1, 2, 3 individually are configured in the vehicle (e.g. a car) to detect the status information such as tire pressure, light device and gasoline fuel/water, etc. The aforementioned status information is transmitted to and processed by processing device 4, and then the processed information is transmitted to be displayed on bi-stable display 5. Taking the electrophoretic bi-stable display as an example, the driving method of such display is performed by shifting the charged color particles with the external electric field to achieve the efficiency of displaying patterns, and the patterns are continuously displayed due to the electrostatic force of particles upon the external electric field is removed. Therefore, the status information can be continuously displayed on the bi-stable display for one to two months. The driver can read the status information of each component of vehicle at any time. If it is desired to update the status information, the commands are inputted into the processing device 4, and the detectors 1, 2, 3 is instructed to detect again and transmit back the updated status information. The status information further can be stored in a memory device 6 connected to the processing device 4. In addition, the driver also can input the previously vehicle's upkeep record to the memory device 6 and display such record on bi-stable display 5 for reminding the driver when the vehicle should be kept up and for displaying the previously component replacement record.

In the vehicle detection system of the first preferred embodiment, detectors 1˜3, processing unit 4, bi-stable display 5 and memory device 6 can be individually configured in different positions of the vehicle, and it is not necessary to be configured in one housing, and these devices are wirelessly and/or electrically connected to each other.

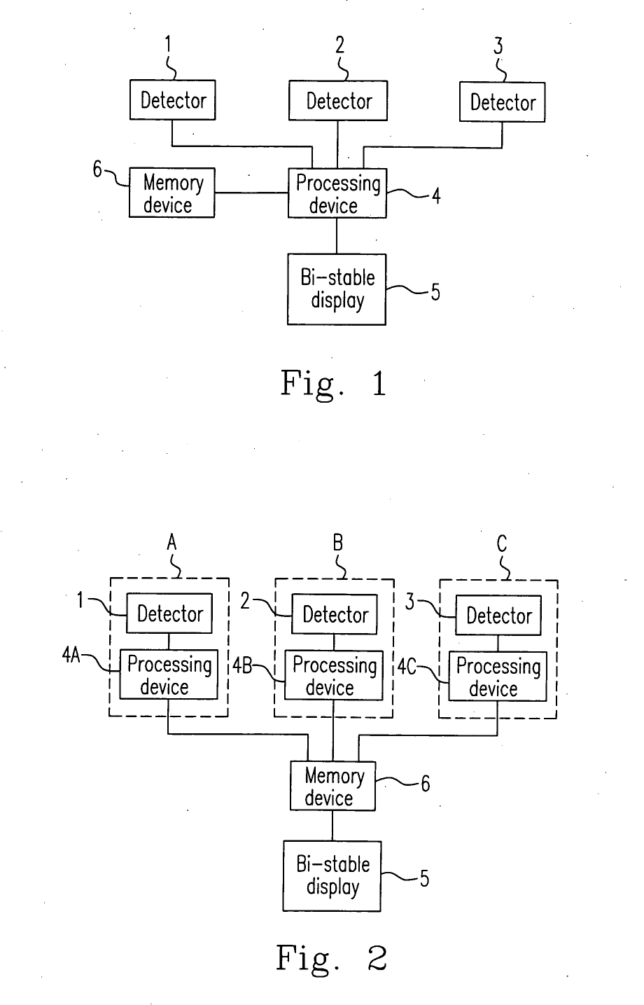

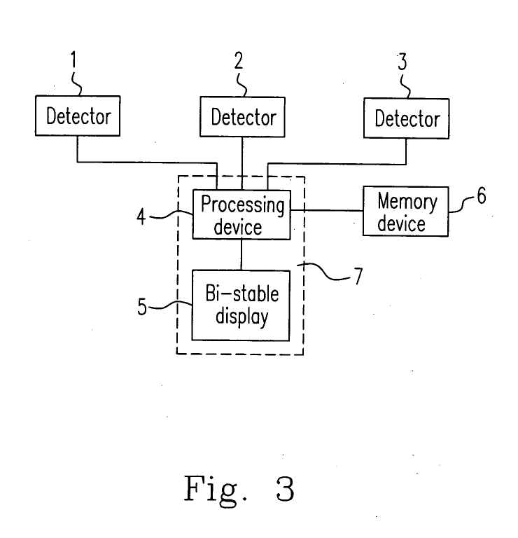

Please refer to FIG. 2, which depicts a diagram showing a vehicle detection system of the second preferred embodiment. Detectors 1˜3 and processing devices 4A˜4C are respectively configured in detector devices A˜C. For instance, detector 1 of the detector device A detects the power system information (such as odometer, speedometer, etc.), detector 2 of the detector device B detects the safety system information (such as air bag, anti-lock blocking system (ABS), etc.), and detector 3 of the detector device C detect the entertainment system information (such as global positioning system (GPS) navigation, audio-video system, etc.). The detected status information respectively are transmitted to and processed by the processing devices 4A˜4C, and then the processed status information is displayed on bi-stable display 5. Preferably, the aforementioned status information also can be stored in the memory device 6, and then transmitted to be displayed on the bi-stable display.

In the third preferred embodiment shown in FIG. 3, the processing device 4 (or control unit) and the bi-stable display 5 are configured in an e-book 7 while detectors 1˜3 and memory device 6 are separately disposed from e-book 7. Detectors 1˜3 transmit the detected status information to processing device 4 for further administration, and then the processed status information is displayed on the bi-stable display 5. The status information or the displayed information is stored in the memory device 6. Alternatively, the processing device 4 reads out the vehicle's inspection record or upkeep/repair record stored in the memory device 6 and shows these records on the bi-stable display 5. Since e-book 7 is wirelessly connected to and/or electrically connected to detectors 1˜3 and memory device 6, the driver can arbitrarily disconnect the connections among e-book 7, detectors 1˜3 and memory device 6 so that the status information still is able to be displayed on the bi-stable display.

The first to the third preferred embodiments are only disclosed based on the vehicle, and the skilled person in this art can broaden the application scope to the environment which configures multiple detectors. The information received by these detectors is displayed on the bi-stable display via the processing device. The display with bi-stable characteristics can be applied in the present invention.

While the invention has been described in terms of what is presently considered to be the most practical and preferred Embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A vehicle detection system, comprising:
a processing device;
a detector connected to the processing device and detecting an information of a vehicle; and
a bi-stable display connected to the processing device and displaying the information processed by the processing device.

2. The vehicle detection system according to claim 1 further comprising a memory device connected to the processing device and storing the processed information.

3. The vehicle detection system according to claim 2, wherein the processing device is in one of two states being wirelessly connected to and electrically connected to the bi-stable display, the memory device and the detector.

4. The vehicle detection system according to claim 1, wherein the bi-stable display is one selected from a group consisting of a micro-electro-mechanical system (MEMS) display, an electrophoretic display, a cholesteric liquid crystal display and an electrowetting display.

5. The vehicle detection system according to claim 1, wherein the information comprises a power system information, a safety system information, a vehicle control information, a driving assistance system information, an entertainment system information and a wireless network information.

6. The vehicle detection system according to claim 1, wherein the information is a status information.

7. A vehicle detection system, comprising:
a bi-stable display; and
a detector detecting an information of a vehicle to be displayed on the bi-stable display.

8. The vehicle detection system according to claim 7, wherein the detector further comprises a processing unit to process the information.

9. The vehicle detection system according to claim 8 further comprises a memory device connected to the processing unit.

10. A display system, comprising:
a bi-stable display; and
a control unit controlling an information to be displayed on the bi-stable display, the information being continuously displayed thereon before updated.

11. The display system according to claim 10, wherein the bi-stable display further comprises a processing device and a memory device, and the processing device processes the information and stores the processed information in the memory device.

12. The display system according to claim 10 further comprising a detector detecting the information and incorporating therein the control unit.
